(19) United States
(12) Patent Application Publication
(10) Pub. No.: US 2023/0016410 A1
(43) Pub. Date: Jan. 19, 2023

(54) SYSTEM FOR DETECTING CROP CHARACTERISTICS

(71) Applicant: GARY W. CLEM, INC., Nevada, IA (US)

(72) Inventors: Patrick H. Clem, Nevada, IA (US); Scott A. Sporrer, Nevada, IA (US); William P. Kelly, Hubbard, IA (US); Justin D. Woods, Ankeny, IA (US); Matthew T. Sobotka, Huxley, IA (US); Cody J. Sobotka, Ankeny, IA (US); Jeff S. Westbrook, Ames, IA (US); Matthew J. Darr, Ames, IA (US)

(21) Appl. No.: 17/858,383

(22) Filed: Jul. 6, 2022

Related U.S. Application Data
(60) Provisional application No. 63/218,729, filed on Jul. 6, 2021.

(51) Int. Cl. G06T 7/00; G06T 7/70; G06V 20/10; G06V 20/56; A01B 79/00; A01B 79/02; A01B 69/00; A01B 69/04; A01D 45/02

(52) U.S. Cl. CPC G06T 7/0012; G06T 7/70; G06V 20/188; G06V 20/56; A01B 79/005; A01B 79/02; A01B 69/001; A01B 69/008; A01D 45/02; G06T 2207/30188; G06T 2207/30242; G06T 2207/30252

(57) ABSTRACT

A crop detection system and method of using the same includes a machine vision system mounted to a mobile vehicle. The machine vision system includes an information capturing device connected to a computer having a processor and memory. The memory includes stored crop and field information. Positioning members are mounted to an extend forward of the mobile structure. The information capturing device includes a camera, a sensor, a transceiver and/or a stereo sensor configuration and is positioned to sense the presence, size, location and orientation of characteristics of a crop.

### CROSS REFERENCE TO RELATED APPLICATION

This application claims the benefit of U.S. Provisional Application Ser. No. 63/218,729 filed Jul. 6, 2021, the content of which is hereby incorporated by reference in its entirety.

### BACKGROUND OF THE INVENTION

This invention is directed toward a system for detecting crop characteristics and more specifically to a system that uses machine vision and/or sensor fusion to collect crop characteristics and make plant parameter predictions.

Collecting information on crops such as corn and more particularly information regarding ears of corn is known in the art. Typically, a number of individuals will walk rows of corn writing down information or inputting information into a computer. Not only is such a system labor intensive, but it is also time consuming, and susceptible to human error. Accordingly, desired is a system that can more easily collect the information and improve the accuracy, but also to use the information to improve seed breeding decisions, plant variations, and planting and harvesting operations.

An objective of the present invention is to provide a crop detection system that is easier and more efficient to use.

Another objective of the present invention is to provide a crop detection system that is more accurate.

These and other objectives will be apparent to one having skill in the art based upon the following written description, drawings and claims.

### SUMMARY OF THE INVENTION

A crop detection system includes a machine vision system mounted to a mobile machine. The machine vision system includes an information capturing device connected to a computer having a processor and memory. The memory includes stored crop and field information. Positioning members are mounted to and extend forward of the mobile machine. The information capturing device includes at least one of a camera, a sensor, a transceiver, and/or a stereo sensor configuration that are positioned to sense the presence, size, location and orientation of crop characteristics. The information capturing device is positioned at multiple locations to capture information from different perspectives.

The method of using the crop detection system includes the steps of mounting the machine vision system to the mobile vehicle and positioning the information capturing device to sense a plurality of crop characteristics under a plurality of conditions. The information capturing device is connected to the computer where crop and field information is stored. Plant characteristics are then detected and transmitted by the information capturing device to the computer where the transmitted information is processed.

The plurality of crop characteristics include a presence, size, location and orientation of plants of a crop. The plurality of conditions include at least one of a time of day where the sun is full, there are shadows, the evening, or dark with artificial light. Other conditions include situations where a plant is partially obscured, where plant orientation varies, where plant color varies, where there are multiple plants, the size of plant and stalk, and the shape and volume of the plant.

In processing the information the computer determines things such as the number of ears present, the height of the ears and one or more plant phenotypic characteristics. The computer also determines the position for optimal placement of the information capturing device for the machine vision system to capture plant information and make predictions regarding plant parameters. Also, the computer determines the plant count, plant color score, ear color score, number of plants, plant spacing, plant diameter, ear diameter, lodging score, height or ear on stalk, and distance of silk to stem. To identify changes from prior readings, multiple readings are taken throughout a growing season to record crop characteristics and calculate differences.

The positioning members are set manually or automatically by an activator controlled by the computer. The positioning members include fingers, flaps, agitators, an air knife, and suction. The positioning members are used to move and manipulate plant materials. Further adjustments are made automatically for pollinating and harvesting based on predictions, as are adjustments to the propel function of the mobile machine and plot management actions.

### BRIEF DESCRIPTION OF THE DRAWINGS

FIG. 1 is a schematic view of an environment for a crop detection system; and

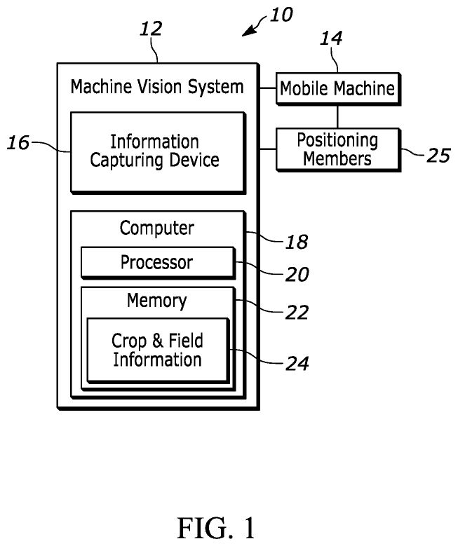

FIG. 2 is a flow diagram of a method for a crop detection system.

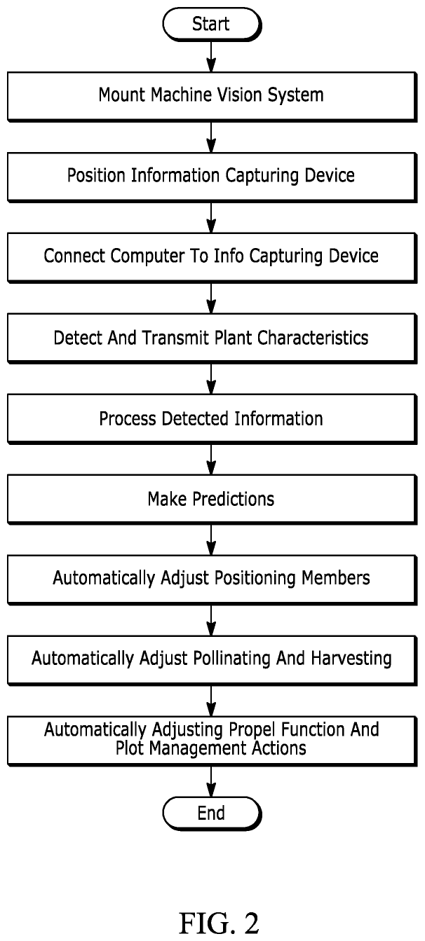

### DETAILED DESCRIPTION

Referring to the Figure, a corn ear detection system 10 includes a machine vision system 12 that is mounted to a mobile machine 14 such as a tractor, harvester, or the like. The machine vision system 12 includes at least one camera and/or sensor and/or transceiver and/or stereo sensor configuration 16 (Visible, IR, NIR, UV, thermal imaging, Radar Rx/Tx, Microwave Rx/Tx, low energy X-Ray) that is positioned to sense the presence, size, location and orientation of an ear of corn at harvest from the mobile machine. Sensing the presence, size, location and orientation of the ear of corn can be dependent upon a variety of conditions that affect the visibility of the ear. The variety of conditions include, but are not limited to, the time of day where there is full sun, shadows, evening, and even at dark with artificial light, (Visible, IR, NIR, UV or other useful electromagnetic spectrums such as Radar and Microwave frequencies or low energy X-Ray). Additional conditions might also include ears that are partially obscured, varying ear orientations, varying ear color, stalks with multiple ears, plant and stalk size, and even the shape and volume of the ear. Desired is to position the camera 16 where the ear, preferably with exposed kernels, is most visible based upon the variety of conditions. Alternatively, multiple cameras 16 are mounted to the mobile machine 14 in order to capture information from different perspectives based on the variety of conditions in order to obtain the best imaging and measurement of the plant characteristics.

The cameras 16 are connected to a computer 18 having a processor 20 and memory 22 that preferably is mounted to the mobile machine 14. Stored within the memory 22 of the computer 18 is crop and field information 24 which includes a variety of information such as field maps, genotypes, phenotypes, and the like. Alternatively, smart cameras could be used to pre-process images such that processed data is then transmitted to the centralized computer. The cameras 16 capture and/or detect plant characteristics and/or information that is transmitted to the computer 18 where the information is further processed, such as whether a single ear is shown or a double ear is present, the height of the ear from the ground, the health or productivity of the ear, and/or one or more additional plant phenotypic characteristics. Additional information either recorded, input, and/or downloaded is data regarding but not limited to plant characteristics as well as the time of day, the time of year, weather conditions, wind conditions, geospatial location and the like. Additionally, based upon the information/data transmitted from the cameras 16 the computer may determine a position for camera placement that is optimal for the machine vision 12 to capture information to make predictions regarding plant parameters. In addition, the computer 18 can deduce a wide variety of other plant characteristics such as but not limited to determining an ear height and an ear count in real time, plant count, plant color score(s), ear color score(s), plant height, number of plants, plant spacing, plant diameter, ear diameter, stalk angle from ground typically referred to as “lodging score” as well as determining the height of the ear on the stalk, the distance of the silk to stem, and the distance to the ground just to name a few. Additionally, the user may use this technology to take this data multiple times throughout the growing season and capture the data. Differences and changes in the crop characteristics can then be recorded and calculated to see the change from the prior data readings.

Manipulation or positioning members 25 are mounted to and extend forwardly of the mobile machine 14. The manipulation members 25 are of any size, shape and structure and as an example can include fingers, flaps, agitators, and positive and negative pneumatic pressure such as an air knife or suction. The manipulation members 25 are used to move and manipulate the plant material and leaves in order to expose more of the ears to the camera and thus improve the performance of the overall system. The position of the manipulating members 25 are either set manually at a predetermined height or automatically by an activator controlled by the computer 18 based upon the type of plant material and the maturity of the plant material.

Computer algorithms are used to fuse camera and/or sensor data into vision and depth predictions to determine the height or three-dimensional location in space of an ear as well as make other measurements, predictions and associated filtering (Kalman filters, extended Kalman filters, etc.) useful to the operation. An additional use of this information gathered is to use it in a manner to make automatic adjustments to field equipment. Based upon the predictions, automated adjustments are made related to but not limited to pollinating and harvesting parameters like height control, width control, and/or lateral (side to side) control based on the measured and/or predicted ear height and/or location. As an example, the predicted ear height and/or silk height relative to the ground is subsequently used to control the height of an individual pollen applicator or multiple applicators grouped in a common bank to better target the corn silks, allowing for improved seed set while using less pollen. In addition, automated adjustment of the propel functions of the mobile machine and plot management actions are made based upon determined predictions. Another feature of the system 10 includes the automation of plant phenotypic information at harvest and user display and spatial mapping across a field.

Information gathered through each pass through the field can be used in real time, or subsequently, to control the operation of the mobile vehicle 14, calculate a plot score, and to inform and instruct an operator. The sensed information is stored and is used for different types of mobile vehicles and applications. As an example, information from an initial pass for harvest, pollen application, pollen collection, or spraying is subsequently used for header automation or a nutrient application.

In addition, the system utilizes various elements such as sensing technology, lift technology, control algorithms and the like in a unique way and for a unique purpose. For example, non-optical sensors are used with a bank lift with a control algorithm to control height relative to approximate silk or other plant component positions. Various boom height control systems are known in the art. Typical systems used in liquid applications involves cases utilizing a plurality of radar or ultrasonic type sensors to determine the height of various points along the boom from the ground and/or the crop canopy as the boom travels through the field. Position data is processed by a controller in real time. Adjustments to the boom height are made such that the average distance from the boom to the ground and/or crop canopy are closer to a target height than is possible without such systems.

Typical booms are composed of a center section of significant length and two wings of significant length. Height adjustment of the center section can be made by raising or lowering the center section. Additional adjustment can be made by rotating the center section, such as left extent of center section raised up relative to right extent of center section, or vice versa. Height adjustment of wings can be made by raising or lowering the center section. Additional adjustment of the wings can be made by pitching the wing extent up or down about a pivot located at the joint to the center section.

In normal operation it is not uncommon for terrain within any of the three straight sections of the boom to vary significantly. Sensors can be placed within each straight section of the boom to detect such variation and maintain an average boom height, or minimum boom height. However, it is not possible to adjust the height nozzles or row units mounting within each boom section relative to the ground or plant.

Typical systems used in detasseling use cases known in the art that use a series of lift arms, each fixed to a straight section of toolbar, to raise or lower groups or banks of row units independently of other row units. Operation is achieved by extending or retracting a hydraulic cylinder linked to the lift arms. One section of the lift arms is fixed to pivot. Change in cylinder length results in opposing extent of the lift arm to rotate about an arc and ultimately adjust height relative to the ground or plant.

Alternate systems use a vertically telescopic carriage that can be raised or lowered by extending or retracting a hydraulic cylinder. Such systems have a linear relationship between cylinder extension and height from the ground or plant. This can be advantageous in the sense that the rate of change in height relative to the ground or plant remains constant throughout the range of motion of the cylinder/device, simplifying control algorithms used to adjust height relative to the ground or plant in real time. Additionally such systems can be packaged smaller.

Both variants of detassel systems typically use two sets of optical sensors to sense the tassel or top of the crop canopy. Two lower sensors are mounted in line horizontally. Two additional sensors, also mounted in line horizontally are offset some distance vertically from the alternate two sensors. The arrangement can be used to define three states. A first state, when no obstruction is detected between either set of sensors, a state is defined that is too far above target. When an obstruction is detected between both sets of sensors, a second or alternate state is defined that is too far below the target. Finally, when an obstruction is detected between the lower set of sensors, but not the upper set of sensors, a third state is defined that is on target. With such a system, the size of the “on target” zone is limited to the distance between the two sensors, meaning feedback to make more finite adjustments is not present.

To improve upon this system more than two sets of optical sensors aligned vertically are used to define additional height states relative to the crop canopy. Optical sensors can work well to detect an undisturbed crop canopy. When the crop canopy has been modified however, such as through detasseling, the system is not ideal. For example, in cases involving application of pollen it is important to target a certain height offset from the height of the corn silk to maximize pollen application efficiency. In other applications, targeting alternate components of the plant such as the ear position, base of the ear, or the like, may be important. In such cases, an offset vertically from the undisturbed crop canopy can be used to approximate the position of the silk or alternate plant component(s) of interest which is used as a target height. Operations such as mechanical detasseling introduce additional variation in canopy height relative to the target plant component, such as the silk, leading to additional error in application height relative to target.

By combining a vertically adjustable lift assembly that is capable of adjusting the height of a single row unit or groups of row units with the use of non-optical sensors such as radar, ultrasonic vision, or the like to determine the vertical position relative to the ground and improvement can be made. Such a system can also be used to determine the height relative to the crop canopy in instances where the crop canopy has been disturbed or not. By utilizing a control algorithm to combine height data relative to the ground with height data relative to the crop canopy, improvement in the approximation of position relative to the silk or other plant component(s) occurs and the height is adjusted accordingly.

Other data can be used to further improve control accuracy relative to a target such as inertial data, hydraulic pressure data of lift components, GPS, vision data or other similar data. The preferred lift assembly utilizes a vertically telescopic carriage that can be raised or lowered by extending or retracting a hydraulic cylinder. Such systems have a linear relationship between cylinder extension and height from the ground or plant. This can be advantageous in the sense that the rate of change in height relative to the ground or plant remains constant throughout the range of motion of the cylinder/device, simplifying control algorithms used to adjust height relative to the ground or plant in real time. Additionally, such systems can be packaged smaller. Alternate lift assemblies such as traditional lift arm type systems can also be used to adjust the height of a single row unit or groups of row units and combined with the disclosed sensing technology. Functions of the mobile machine, such as a change of speed, settings, and/or actual decisions typically made by humans are done automatically based upon captured information from the sensors for functions of the machine to change on the fly according to the environment the mobile machine is working in.

In one example one radar or ultrasonic sensor is used to simultaneously detect the crop canopy and the ground. Alternatively, two separate sensors mounted vertically could be used. Then, the ground height and a ratio of the canopy compared to a desired application height is used to approximate and control the system for the ideal application height. In other words, the height for shorter or taller plants would be adjusted for.

In operation, first the ground data is used to determine the distance from the sensor to the ground. Then, the canopy data is used to determine the distance from the sensor to the canopy. Next, the distance between the boom and the canopy is used to determine the height of the canopy. A set ratio of the target height as compared to the canopy height is then used to determine a target height (i.e. target height is 60% of canopy height). Finally, to control the target height, an offset between the target height and the sensor height (i.e., the distance from the applicator nozzle to the sensor) is used. The following are examples of using the method:

1. Application offset is −35″ from sensor (sensor is mounted 35 inches above nozzle)

2. Sensor is 60 inches above ground (nozzle is 25″ above ground);

3. Sensor is 10 inches above canopy (canopy height=60″−10″=50″);

4. Application ratio is set to 60% of canopy (50″*60%=30″);

5. New target control height (for taller plants) is 30″;

6. Adjusts in real time.

Example using simple fixed offset (norac/raven) from canopy in tall crop:

1. Application offset is −35″ from sensor;

2. Control target is 10″ above canopy;

3. Canopy height=75″;

4. Application height=75″+10″−35″=50″ (about right);

5. Compares to 51″ using above method.

Example using same simple fixed offset (norac/raven) from canopy in short crop:

1. Application offset is −35″ from sensor;

2. Control target is 10″ above canopy;

3. Canopy height=40″;

4. Application height=35″+10″−35″=10″ (too low);

5. Compares to 24″ using above method.

Accordingly, a system has been disclosed that can adjust the height of a single row unit or groups of row units relative to the ground, crop canopy, or other plant components that improves upon the art. In addition, a system 10 has been disclosed that provides information on ears of corn, and improves upon the art. From the above discussion and accompanying figure and claims it will be appreciated that the system 10 offers many advantages over the prior art. It will be appreciated further by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A crop detection system, comprising:
a machine vision system mounted to a mobile machine wherein the machine vision system includes an information capturing device;
a computer having a processor and memory is connected to the information capturing device;
the memory including stored crop and field information; and
positioning members mounted to and extending forward of the mobile machine.

2. The system of claim 1 wherein the information capturing device includes at least one selected from a group consisting of a camera, a sensor, a transceiver and a stereo sensor configuration.

3. The system of claim 1 wherein the information capturing device is positioned to sense the presence, size, location and orientation of characteristics of a crop.

4. The system of claim 3 wherein the information capturing device is positioned at multiple locations to capture information from different perspectives.

5. A method of detecting crop characteristics, comprising the steps of:
mounting a machine vision system having an information capturing device to a mobile vehicle;
positioning the information capturing device to sense a plurality of crop characteristics under a plurality of conditions;
connecting a computer to the information capturing device and storing in memory of the computer crop and field information;
detecting and transmitting plant characteristics with the information capturing device to the computer; and
processing the information with the computer.

6. The method of claim 5 wherein the plurality of crop characteristics includes a presence, size, location, and orientation of plants of a crop.

7. The method of claim 5 wherein the plurality of conditions includes at least one selected from a group consisting of a time of day where the sun is full, there are shadows, the evening, or dark with artificial light.

8. The system of claim 1 wherein the information capturing device includes at least one selected from a group consisting of a camera, a sensor, a transceiver and a stereo sensor configuration.

9. The system of claim 3 wherein the information capturing device is positioned at multiple locations to capture information from different perspectives.

10. The method of claim 5 wherein the plurality of conditions includes at least one selected from the group consisting of where a plant is partially obscured, where plant orientation varies, where plant color varies, where there are multiple plants, size of plant and stalk, and shape and volume of the plant.

11. The method of claim 5 wherein the computer determines the number of ears present, the height of the ears from the ground, the health of the ears, and one or more plant phenotypic characteristics.

12. The system of claim 5 wherein the computer determines the position for optimal placement of the information capturing device for the machine vision system to capture plant information and make predictions regarding plant parameters.

13. The system of claim 5 wherein the computer further determines at least one selected from the group consisting of plant count, plant color score, ear color score, number of plants, plant spacing, plant diameter, ear diameter, lodging score, height of ear on stalk, and distance of silk to stem.

14. The system of claim 5 wherein multiple readings are taken throughout a growing season where crop characteristics are recorded and calculated to identify changes from prior data readings.

15. The method of claim 5 further comprising the step of mounting positioning members to extend forwardly of the mobile machine.

16. The method of claim 15 wherein the position of the positioning members is set automatically by an activator controlled by the computer.

17. The system of claim 1 wherein the manipulation members include at least one selected from a group consisting of fingers, flaps, agitators, an air knife, and suction.

18. The method of claim 15 further comprising the step of moving and manipulating plant material using the positioning members.

19. The method of claim 12 wherein automated adjustments are made based upon captured information to the mobile machine.

20. The method of claim 12 wherein automated adjustments are made based upon the captured information and the current environment to the mobile machine.
